(19) United States
(12) Patent Application Publication
(10) Pub. No.: US 2026/0161199 A1
(43) Pub. Date: Jun. 11, 2026

(54) ACTUATOR BUTTON FOR MOBILE DEVICE PROTECTORS

(71) Applicant: Casetagram Limited, Hong Kong (HK)

(72) Inventors: Pui Sun Wesley NG, Hong Kong (HK); Margaret Alice BURKE, Hong Kong (HK); Chung Nam Allen CHAN, Hong Kong (HK); Satoshi MATSUDAIRA, Hong Kong (HK)

(21) Appl. No.: 18/969,322

(22) Filed: Dec. 5, 2024

(51) Int. Cl. G06F 1/16; G05G 5/03; G06F 3/044

(52) U.S. Cl. CPC G06F 1/1656; G05G 5/03; G06F 1/1684; G06F 3/044

(57) ABSTRACT

A mobile device protector (e.g., a mobile phone case) has an edge wall portion including at least one region covering a mobile device capacitive actuator button on a mobile device. The mobile device capacitive actuator button is adjacent an at least partially electrically conductive region with a conductivity sufficient to transmit a change in capacitance due to a user's digit or stylus approaching the mobile device capacitive actuator button on the mobile device for actuating the mobile device capacitive actuator button as a result of a change in capacitance. The conductive materials may be integrated into the mobile device protectors themselves or may be conductive material-based button insert that is placed within a mobile device protector. The conductive buttons may have numerous internal conductive configurations including uniform conductor distribution, non-uniform conductor distribution, layered conductor distribution, or discontinuous conductor distribution caused by apertures or insulator regions in the conductive polymer.

### BACKGROUND

Mobile phones, tablets, and other portable electronic devices include a variety of touch-based actuator buttons. In particular, capacitive touch sensor buttons are frequently used to register user input. This input may be in the form of a single touch, a swipe or other gesture, or a combination of inputs. Although such capacitive control buttons are typically used through a screen-based display, these buttons may be mounted anywhere on the electronic device. In particular, various mobile phones such as the iPhone 16 include capacitive control buttons on the edge of the phone housing as slider actuator buttons to control camera zoom levels. Such capacitive buttons may also include traditional click actuation, by depressing the button, in order to take a photograph. That is, a single capacitive control button can be both a capacitive slider as well as a click actuator button. An example of the iPhone camera actuator button is depicted in FIG. 1.

Clicking the camera control button of FIG. 1 brings up various control screens while sliding across the top surface of the button moves a cursor back and forth for a setting that is shown on the LCD display on the face of the phone. This is because there is both a force sensor and a touch sensor integrated within the button.

Within this button is a multipixel capacitive sensor as shown in FIG. 2. Capacitive touch sensors work by detecting the change in capacitance that occurs when a conductive object, like a finger, approaches the sensor's surface. There are various approaches to capacitive touch sensors based on projected capacitance, for example, mutual capacitance sensors or self-capacitance sensors. In general, capacitive sensors include conductive electrodes that create an electrostatic field. When your finger (which contains conductive ions) gets close, it disturbs this field and changes the capacitance at that location. The capacitive sensor's electronics continuously measure the capacitance. When the finger comes close, it alters the capacitance value, which the system interprets as a touch. The sensor converts the change in capacitance into an electrical signal, which the device interprets to perform actions, like registering a button press or touch. In a mutual capacitive sensor, a capacitor is formed at each intersection of a row and column electrode formed in a grid pattern. The change in capacitance at any grid intersection will give the position of the touch based on measuring voltage in another grid axis. In self-capacitance sensors the rows and columns are independent such that current will sense the location of the touch at each column or row.

For more complex capacitive touch sensor such as a capacitive slider button, there are additional design considerations. Capacitive slider buttons work primarily by detecting the continuous movement of a finger across a sensor strip, allowing for a sliding or scrolling interaction. They can operate based on either self-capacitance or mutual capacitance, each with specific advantages and trade-offs. In a self-capacitance slider, each electrode or sensor pad along the slider measures its own capacitance with respect to a reference ground. When a finger comes close, it changes the capacitive load of each individual electrode in proximity, which the system can sense as a touch. As the finger moves along the slider, the change in capacitance shifts from one electrode to the next. In a mutual capacitance sider button using a cross-electrode technique, two sets of electrodes (e.g., rows and columns) are arranged in close proximity, with a small gap between them. Each intersection of a row and column electrode forms a localized electric field. When a finger approaches, it interferes with the electric field between the intersecting electrodes at that location, altering the mutual capacitance. As the finger slides, this disturbance in mutual capacitance shifts across successive intersections, enabling accurate tracking of finger movement along the slider. Although mutual capacitive sliders have the ability to track more complex finger movements, they require more complex electronics.

When the capacitive slider also includes a standard “click” actuator, this may be a separate mechanical switch located beneath the capacitive slider as in the iPhone 16 button depicted above. This allows the user to press down on the slider surface itself, engaging a separate mechanical switch beneath the slider layer. The electronic device (mobile phone, tablet, laptop) control system will differentiate between capacitive and mechanical inputs to perform the respective functions of each.

Many mobile phone owners employ protective phone cases or other protective elements to cover the back and sides of the phone, protecting the phone in the event of a fall or other accident. However, when capacitive actuator buttons are used on the sides or back of the mobile phone, the traditional techniques of having a click-based actuator button protrude through a phone case aperture are not satisfactory for the phone user. This is because such capacitive buttons are often flush with the side of the mobile phone and will not protrude beyond the phone case thickness. Although a large aperture cut-out may be used, this cut-out does not permit natural sliding along the capacitive slider button surface which will be recessed relative to the phone case exterior. Further, using an extremely large aperture to facilitate swipe movements results in insufficient protection for the mobile phone.

Thus, there is a need in the art for improved mobile phone cases that can actuate a capacitive button through a suitable region of the mobile phone case designed to accurately convey the user touch or slide along a region positioned above the phone's capacitive actuator button. The present invention addresses this need.

### SUMMARY OF THE INVENTION

The present invention presents several alterative embodiments employing conductive materials that accurately convey a change in capacitance caused by a human finger or stylus approaching a capacitive actuator button positioned on a mobile device (typically on the side of the mobile device but may also be on the back or front of the mobile device as well as the top and bottom edges). The conductive materials may be integrated into the mobile device cases/protectors themselves or may be conductive material-based button insert that is placed within a mobile device case/protector. The conductive buttons may have numerous internal conductive configurations including uniform conductor distribution, non-uniform conductor distribution, layered conductor distribution, or discontinuous conductor distribution caused by apertures or insulator regions inserted into the conductive polymer. Each of these will be described in greater detail below.

In an embodiment, the invention includes a mobile device protector having an edge wall portion including at least one region covering a mobile device capacitive actuator button on a mobile device and the mobile device capacitive actuator button is adjacent to the at least one region. At least one region is an at least partially electrically conductive region with a conductivity sufficient to transmit a change in capacitance due to a user's digit or stylus approaching the mobile device capacitive actuator button on the mobile device for actuating the mobile device capacitive actuator button as a result of a change in capacitance.

In a further aspect, the mobile device protector includes a mobile device protector button.

In a further aspect, the mobile device protector device protector button includes at least one electrically conducting region and at least one electrically non-conducting region.

In a further aspect, the at least one electrically conducting region includes a conductive polymer.

In a further aspect, the conductive polymer is in the form of conductive particles, wire, or rod.

In a further aspect, the conductive particles, wire, or rod is embedded in a polymer matrix.

In a further aspect, the conductive particle, wire, or rod at least partially includes carbon, graphite, carbon nanotubes, graphene, silver, copper, aluminum, nickel, conductive ceramics, or mixtures thereof.

In a further aspect, polymer matrix includes an elastomer, a thermoplastic resin, a thermoset resin, or mixtures thereof.

In a further aspect, the polymer matrix includes an elastomer selected from one or more of silicone, polyurethane, thermoplastic polyurethane, thermoplastic elastomers, or acrylonitrile butadiene styrene (ABS).

In a further aspect, the polymer matrix includes a thermoplastic resin or a thermoset resin selected from polyethylene, polyethylene terephthalate, polytetrafluoroethylene, polystyrene, polycarbonate, polybutylene, polyvinyl chloride, polyester, polyimide, polyamide, or polypropylene.

In a further aspect, the mobile device protector button includes vertical or horizontal layers of conducting and nonconducting regions.

In a further aspect, the mobile device protector button includes apertures or voids therewithin.

In a further aspect, the mobile device protector button is positioned to be at least partially physically separated from the mobile device capacitive actuator button by an air gap before actuation.

In a further aspect, upon actuation of the mobile device protector button, the mobile device protector button is configured to displace the air gap and press against the mobile device capacitive actuator button on the mobile device.

In a further aspect, the mobile device protector button includes embedded sliding element and the mobile device protector button is positioned within a groove of the mobile device protector.

In a further aspect, the embedded sliding element is in the form of a conductive rod, conductive spheres or conductive bead.

In a further aspect, the mobile device protector button includes a protective layer positioned between the mobile device protector button and the mobile device capacitive actuator button.

In a further aspect, the mobile device protector button further comprises a haptic feedback module.

In a further aspect, the edge wall portion at least partially extends from the back panel.

In a further aspect, a second edge wall portion at least partially extends from the back panel.

### BRIEF DESCRIPTION OF THE DRAWINGS

FIG. 1 depicts a phone actuator button for an iPhone 16;

FIG. 2 depicts multipixel capacitive sensor;

FIG. 3A-3C depict several variants of mobile phone case/protector incorporating a conductive polymer actuator button according to any of the embodiments described herein;

FIG. 4 depicts a uniform conductive polymer actuator button according to an embodiment;

FIG. 5A-5C depict a discontinuous conductive polymer actuator button according to an embodiment;

FIGS. 6A-6B depicts an apertured conductive polymer actuator button according to an embodiment;

FIG. 7 depicts a layered conductive polymer actuator button according to an embodiment;

FIG. 8 depicts a conductive polymer button with a formed air gap according to an embodiment;

FIG. 9 depicts a phone case/protector button with customizable conductive regions;

FIG. 10 schematically demonstrates a cross-section of a mobile phone case/protector button with a protective layer;

FIG. 11 is a side-view in cross-section of a slidable mobile phone case/protector button;

FIG. 12 is a perspective view of a further embodiment of a slidable mobile phone case/protector button;

FIG. 13 is a perspective view of a further embodiment of a slidable mobile phone case/protector button;

FIG. 14 schematically demonstrates a cross-section of a mobile phone case/protector button with a haptic feedback module;

FIG. 15 schematically depicts a protective element over a mobile device case/protector cut-out portion.

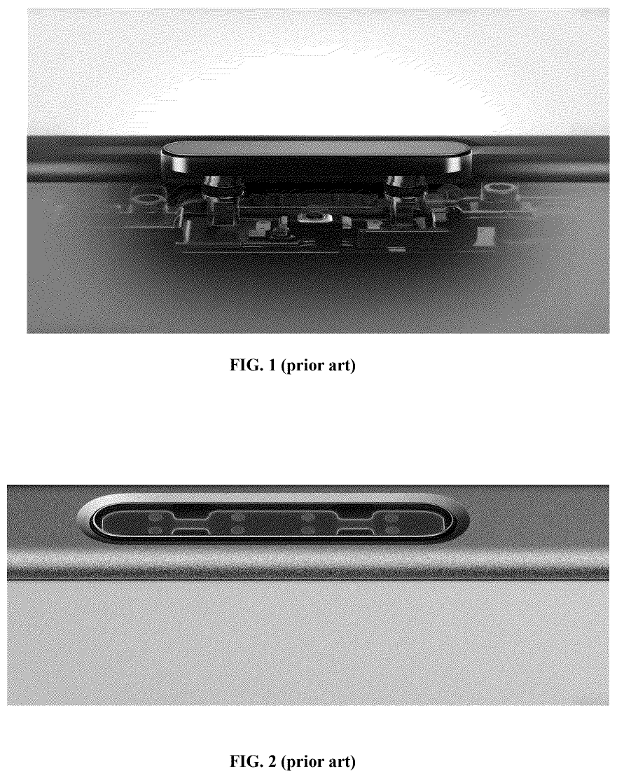

### DETAILED DESCRIPTION

The present invention provides a variety of mobile device cases/protectors that include conductive materials that are positioned over capacitive mobile device actuator buttons. The conductive materials accurately convey the change in capacitance caused as a human finger touches the conductive material region, transmitting this to the device's capacitive actuator button. The conductive material may be in the form of a conductive region integrated into the mobile device case/protector or, alternatively, may be a discrete button on the mobile device case/protector. The embodiments below are shown configured particularly for mobile phones; however, it is understood that the mobile device cases/protectors may be for a wide range of portable electronics include, but not limited to, mobile phones, tablets, laptops, music players, fitness trackers, watches, personal digital assistants, or other portable electronic devices that use protective cases/protectors.

To create capacitive sensors in mobile devices such as phones, tablets, and laptops, layers of conductive and insulating materials are formed to optimize sensitivity, durability, and manufacturing ease. For an LCD display, the top electrode material is typically required to be a transparent material. Therefore, the top electrode is often selected to be indium tin oxide (ITO) as ITO is transparent and conductive, allowing it to be used on displays without blocking visibility. It can be formed on a glass display cover. When visibility is not required, another conductor such as copper, silver, or a metal mesh may be used.

As a dielectric central capacitor layer, glass or plastic (PET, PC) may be used as these materials are durable and can have the bottom electrodes easily formed on the opposite side. Additional coatings such as silicone or other dielectrics may be used to tune the dielectric constant of the capacitive sensor. The lower electrode/electrode grid may be formed from any conductor as it typically does not to be transparent.

As an object approaches the capacitive sensor, the overall change in capacitance is registered. Therefore, any buttons or regions of protective elements must be able to properly convey this change in capacitance to the capacitive sensor used as an actuator.

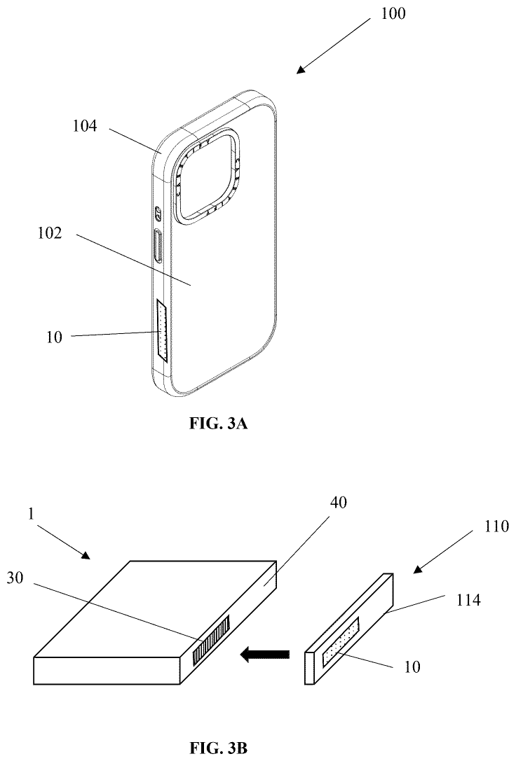

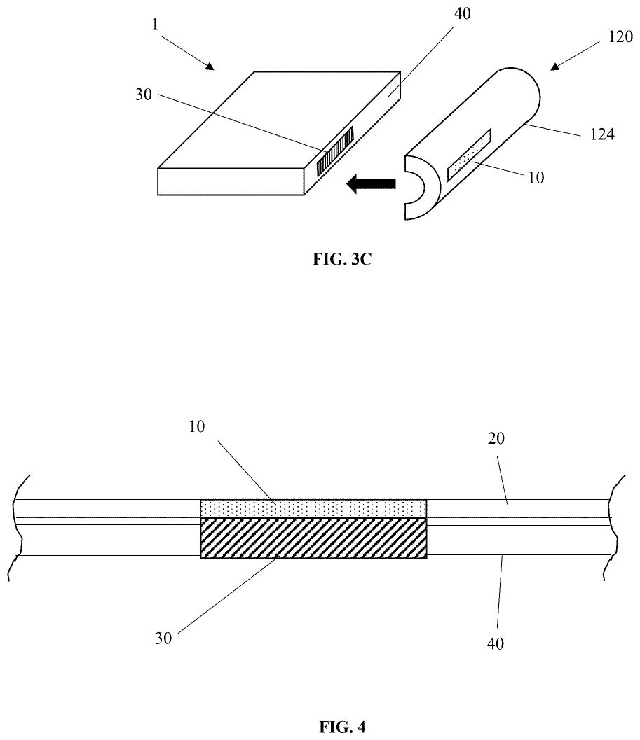

FIG. 3A depicts a typical mobile device case/protector 100, such as a phone or tablet case/protector. As seen in FIG. 3A, the mobile device case/protector 100 includes a back panel 102 having edge wall portions 104 that at least partially extend from the back panel 102.

FIG. 3B depicts a “minimalistic” mobile device protector 110 including at least one edge wall portion 114 with or without a back panel. The mobile device protector 110 is configured to be attached (e.g. by adhesion) to at least one edge of the mobile device body 40 of the mobile device 1.

FIG. 3C depicts another “minimalistic” mobile device protector 120 including at least one edge wall portion 124 with or without a back panel. The mobile device protector 120 is configured to be attached (e.g. by adhesion, friction, snap-fitting, etc.) to at least one edge of the mobile device body 40 of the mobile device 1.

In any of the mobile device cases/protectors described herein, the entire side of the device 1 may be covered or partially covered. One or more side edges may be exposed or partially exposed, for example, to give access to charging ports or to SIM card ports or memory card ports. In the mobile device case/protector 100, at least one of the first or second edge wall portions 104 or the back panel 102 includes at least one region covering a mobile device capacitive actuator button 30 on the mobile device 1 adjacent to the at least one region. In the “minimalistic” mobile device protector 110, 120, at least one edge wall portion includes the at least one region covering the mobile device capacitive actuator button 30 on the mobile device 1 adjacent to the at least one region.

The at least one region may be a discrete button or a conductive region fully integrated with mobile device cases/protectors 100, 110, 120. When a discrete button is selected for the mobile device case/protector, the button shape may be selected such that the user can feel the button region without having to visually discern where the button is placed. For example, the button, even when integrated with the case/protector, may protrude slightly to provide tactile confirmation of its placement. Further, for actuating a capacitive slider button on the electronic device that also responds to click actuation, the button material or case/protector material is sufficiently flexible to permit click actuation in the usual manner.

Turning to FIG. 4, the conductive button 10 may be a thin uniformly-conductive polymer or thin uniformly-conductive elastomer. Button 10 may form a portion of the mobile device case/protector 20 and is positioned above mobile device capacitive actuator button 30 disposed on the mobile phone body 40. As most polymers are insulating materials, conductive polymers are typically created by adding conductive fillers. Non-exhaustive examples of polymers include thermoplastic polymers such as polyethylene, polyethylene terephthalate, polytetrafluoroethylene, polystyrene, polycarbonate, polybutylene, polyvinyl chloride, polyester, polyimide, polyamide, and polypropylene. Non-exhaustive examples of elastomers or partial elastomers include silicones, polyurethanes, thermoplastic polyurethanes (TPUs), thermoplastic elastomers (TPEs), and acrylonitrile butadiene styrene (ABS). Non-exhaustive fillers include carbon black (e.g., 10-100 nm particle size), carbon nanotubes (1-20 nm particle size), graphene/graphene oxide (1-20 nm particle size), silver (1-20 micron particle size), nickel (5-20 micron particle size), or copper (1-50 micron particle size). These fillers may be used alone or in combination with each other or with other fillers. Particle sizes represent typical commercially-available particle sizes and are not limiting. Volume resistivity of the formed conductive polymers may have a wide range of approximately 10⁻⁶ to 10⁰ Ω·cm. The selected thickness of the conductive polymer button will, in part, dictate the selected conductivity.

The volume percentage of conductive particles is selected based on the overall desired conductivity and typically ranges from about 1 percent to about 30 volume percent depending upon the selected particles. More particularly, the range may be from about 10-20 percent in some embodiments.

Since the button material conducts electricity, the capacitive field change is transmitted. In one embodiment, the conductive polymer is selected to be sufficiently thin such that the distance from the underlying capacitive actuator button is small, minimizing the impedance between the finger and the sensor. This thickness may be on the order of 1 mm, depending upon the material's dielectric constant and conductivity. In this embodiment, the conductive polymer button uniformly transmits the change in electrical field caused by a user's touch to the capacitive actuator button beneath the button. As seen in FIG. 4, conductive button 10 is in contact with mobile phone capacitive actuator button 30. While this design is sufficient for a capacitive actuator button, it may lack sufficient sensitivity for capacitive slider buttons.

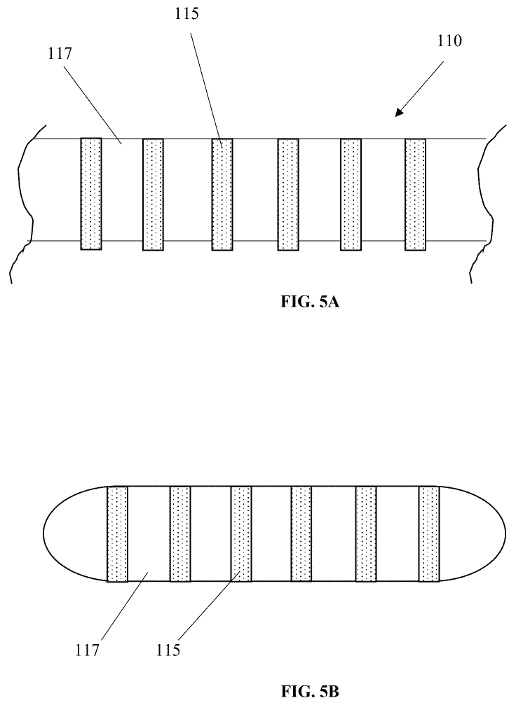

FIGS. 5A-5C depict an embodiment of a discontinuous conductive polymer button 110 according to an embodiment. FIG. 2A is a cross-section of button 110 which is positioned within a case/protector 20 as shown in FIG. 4, that is, in contact with a mobile phone capacitive actuator button 30. The embodiment of FIG. 5A is particularly configured for capacitive slider actuator buttons that may need a more sensitive indication of finger movement across the button surface. In button 110, conductive regions 115 are formed between non-conductive regions 117 in order to sequentially transmit the change in capacitance as the finger or stylus swipes across the button surface (for example from left to right or right to left in FIG. 5A). The conductive regions 115 may be formed from conductive fillers as in the embodiment of FIG. 4; the fillers are periodically distributed throughout the polymer thickness from top to bottom. In other aspects the discontinuous pattern may be a conductive mesh, thin segmented traces, or a series of conductive “islands” formed by metal foils or paints along the slider's direction. FIG. 5B depicts the filler distribution as seen in a top view; FIG. 5C depicts an alternative filler distribution as seen in a top view. These conductive regions may form “conductive walls” or “conductive pillars” that extend from top to bottom through the button.

By using discontinuous conductive regions along the slider length, separated by insulating voids, individual sections transmit localized capacitive field changes more accurately, letting the capacitive slider below track the finger's movement across each segment. The voids between segments prevent a single continuous field that would interfere with detecting sliding motion. As the user slides a finger across the elastomer, only the regions directly under the conductive walls or pillars transfer the change in capacitance. By separating conductive walls or pillars with an insulating material, signal bleed across the surface is prevented. This helps maintain a more precise control of capacitance changes in that only the areas directly under the finger would create detectable signals. Further, smooth transitions are promoted by the conductive walls or pillars as they sequentially come into contact with the capacitive slider at different points, the sensor can track the movement in a more granular manner, which is ideal for slider-type buttons where precise detection of finger motion is key. Because the conductive pillars are spaced apart, they can mimic the behavior of a finger sliding across a surface. As capacitive sliders work by detecting small changes in capacitance as the user's finger approaches or moves away from the sensing electrodes discrete conductive regions create a similar capacitance gradient that helps the capacitive actuator button more easily track movement.

In general, smaller, closely-spaced walls or pillars can help ensure that enough capacitance change occurs at each point of interaction, improving sensitivity and resolution for the slider. The distance between the conductive walls or pillars (spacing) will determine how many walls or pillars come into contact with the capacitive slider at a given time. The spacing needs to be fine enough to ensure continuous interaction during a swipe, but not so close that it behaves like a solid conductive sheet, which might block proper detection of the swipe. The conductive material used for the walls or pillars should have low enough resistivity to allow for effective capacitance transfer. This ensures that the electrical charge can travel through the walls or pillars and influence the capacitance of the slider's electrodes below. Thus, the choice of fillers can create the correct low-resistivity regions.

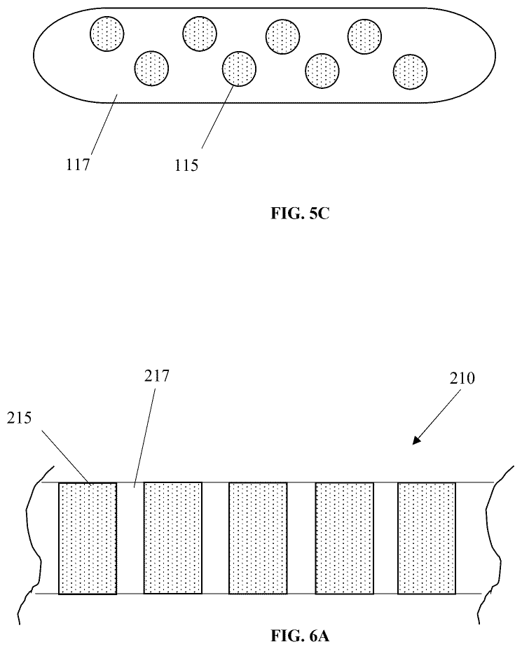

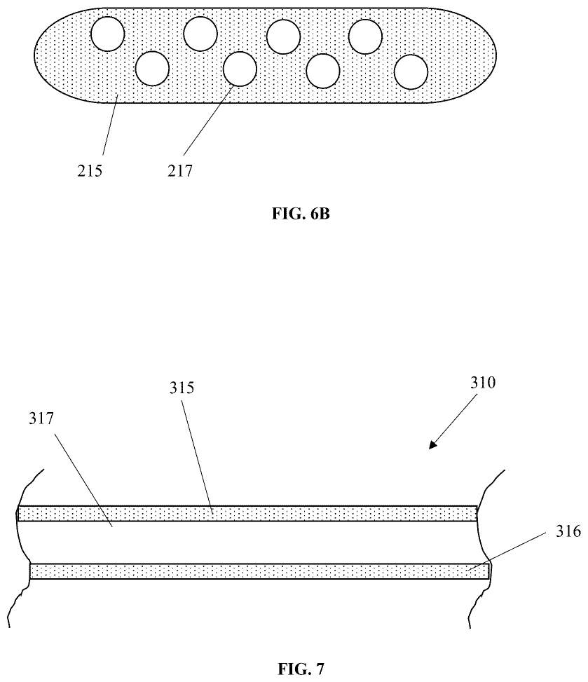

FIGS. 6A-6B depict a further embodiment of a polymer button with conductive and non-conductive regions. In the embodiment of FIG. 6A-6B, the insulating regions 217 are formed by apertures in the polymer button. In FIG. 6A, a side view is depicted showing the apertures extending from top to bottom. The apertures may be formed in a random pattern as in FIG. 6B or may be formed in a linear pattern such that a finger swiping button 210 sequentially moves from a conductive polymer region 215 to an aperture 217 (non-conducting region).

FIG. 7 depicts a further embodiment of a polymer button with conductive and non-conductive regions. In FIG. 7, a top conductor region 315 and a bottom conductor region 316 are formed from a conductive polymer or conductive paint or metal region separated by insulating region 317. The top and/or bottom conductor regions 315, 316 may be continuous or discontinuous in a linear or non-linear pattern (e.g., as in FIGS. 6A-6B). In this manner, one or more capacitors are formed by button 310 such that the capacitor is combined with the capacitive touch button of the phone or mobile device. The phone case/protector capacitor button 310 will change the capacitance of the underlying electronic device capacitive button. In one aspect, only one surface may be discontinuous, for example, either the top surface or the bottom surface.

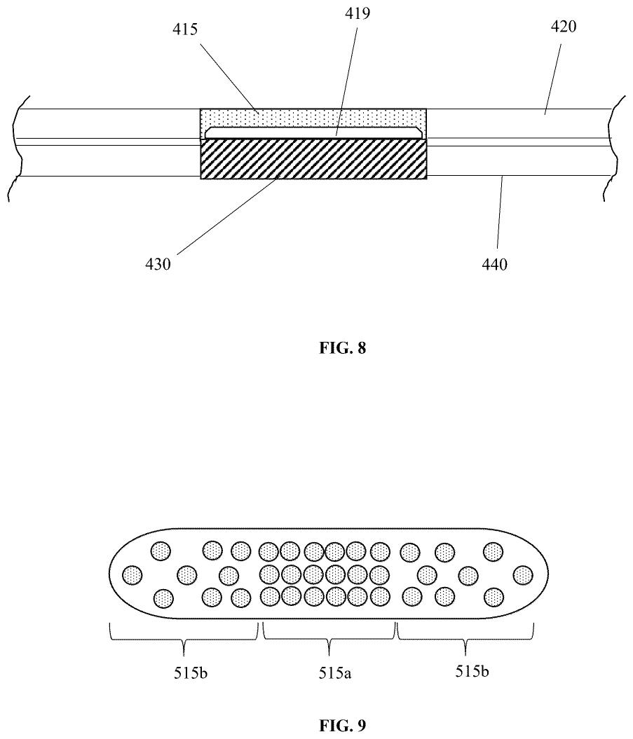

FIG. 8 depict a further embodiment in which the conductive polymer 415 is positioned to be at least partially physically separated from the phone actuator button 430 by an air gap 419 formed therebetween before actuation. For a sufficiently resilient material and a sufficiently small air gap 419, the action of swiping the material will sequentially displace the air gap 419 and press the conductive polymer 415 against the phone actuator button 430, creating the desired change in capacitance of a swipe material. This sequential, localized contact mimics a sliding interaction because it introduces a touch-like capacitive event at each location as the conductive polymer 415 compresses and completes the circuit with the underlying electrodes. The temporary contact between the conductive polymer 415 and the phone actuator button 430 will create a localized change in capacitance, similar to what would happen if the finger itself were directly sliding on the sensor. The capacitive actuator button 430 can then detect these changes as they move along the length of the slider, interpreting it as a sliding touch. Improved signal precision may result as accurate finger tracking is maintained through sequential contact. Further, the air gap 419 acts as a natural insulator, reducing unintended capacitive coupling and isolating the conductive polymer's contact to specific points on the phone actuation button.

Because the conductive materials of the present invention may be polymeric materials, they may easily be integrated into polymer cases/protectors. In particular, if the material of the polymeric button (e.g., TPU) is the same base material as the polymeric case/protector (also TPU), the integration of the button with the case/protector is simplified such that production costs are reduced and production yields are increased. Typical case/protector materials include TPU, silicone, polycarbonate and hybrid cases/protectors using multiple materials (for example, silicone anti-impact liners in a harder outer shell case/protector).

To integrate the conductive polymer button to the device case/protector, an overmolding process may be used in which the button is directly molded into the case/protector during manufacture of the case/protector. Overmolding creates a seamless and secure bond between the materials, ensuring that the conductive polymer button remains in the correct position by molding into the specific location where the capacitive slider is situated. Alternatively, a conductive polymer button can be adhered using conductive adhesives or other bonding agents to the case/protector. A snap-fit may also be used with slots or tabs between the button and the case/protector to retain the button in the correct location.

Although the above embodiments have been discussed using polymers and conductive polymers, it is understood that other conductive materials may be used to create conductive regions within a polymer button. For example, portions of circuit boards that include conductive and insulating regions in various patterns may be selected. Alternatively, wires or larger discrete metal particles may be used to create any arbitrary conductive pattern that can convey the different touches of a human finger or stylus. In some embodiments, a conventional phone case/protector may be used with only one or more layers of metal foil on the top, the bottom, the top and the bottom, or embedded within the case/protector to transmit the changes induced by a finger or stylus. Metal foils can be formed in continuous or discontinuous patterns as shown in the above embodiments.

Additionally, depending upon the desired control characteristics of the capacitive actuator button, various custom conductive profiles may be constructed to tailor the sensitivity of the phone case/protector button in different regions. For example, as seen in FIG. 9, the phone case/protector button may have higher conductivity in a central region with larger numbers of conductive elements 515a while having fewer conductive elements 515b on either side. These conductive elements may be any of the metal or conductive polymer materials described in the embodiments above. Consequently, the case/protector button exhibits greater touch sensitivity in the central region in this example. Depending on the functionality of the phone capacitive button, the phone case/protector can have increased conductivity in the regions where more control functions are located, for example.

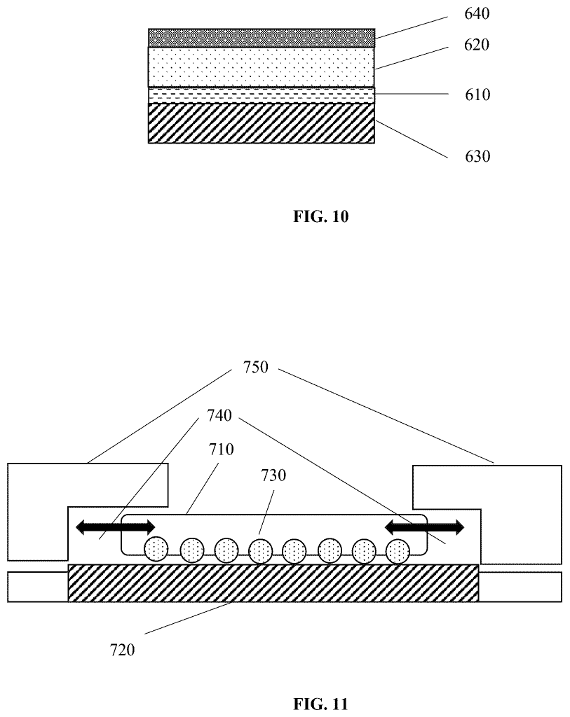

For embodiments using metal particles or wires, the material of the underlying phone actuator button can be protected from scratches or other damage caused by the metal by including a protective layer between the phone case/protector conductive button and the phone button. As seen in FIG. 10, a protective layer 610 is provided between the conductive button 620 (of any of the above configurations) and the phone actuator button 630. The protective layer may be a thin dielectric capacitor layer with relatively lower hardness than the phone actuator button, including, for example, glass, plastic (such as PET or PC) or any materials suitable for making screen protectors. Optionally, an additional protective/decorative layer (e.g. silicone or other plastic) 640 may be applied on the user facing side of the conductive phone case/protector button 620.

For buttons that may require greater degrees of mechanical freedom, a phone case/protector conductive button may be a slidable button 710 over the mobile phone capacitive button 720 as seen in FIG. 11. The sliding elements 730 may be embedded in the slidable button 710 or they may be separable from the slidable button 710. The button may be retained within a groove 740 of the phone case/protector 750.

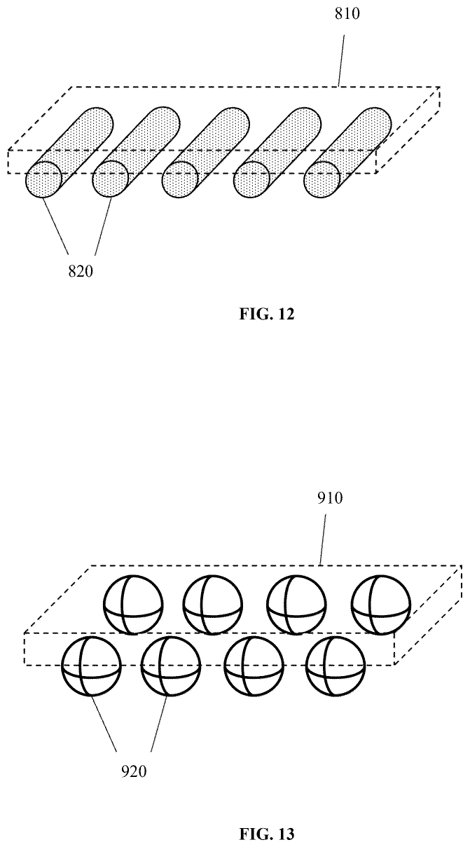

FIG. 12 shows a variant of a slidable phone case/protector button 810 that includes conductive rods 820 that slide/roll across the surface of a capacitive button on an underlying phone (not shown in FIG. 12). Alternatively, each conductive rod 820 may be independently rotatable similar to a wheel structure of a trolley with multiple wheels supporting a trolley car.

In a further alternative shown in FIG. 13, the rods may be substituted by conductive spheres or beads 920 which may be fixed within the phone case/protector button 910. The beads may be rotatable, for example, ball bearing type spheres, or fixedly embedded within button 920.

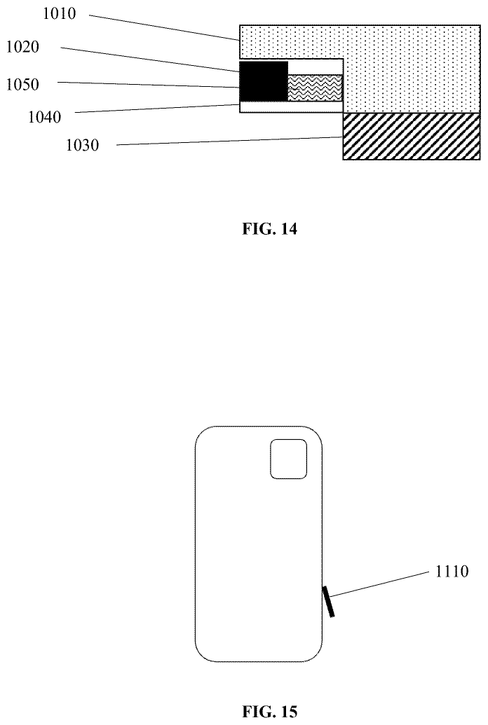

In a further embodiment shown in FIG. 14, a haptic feedback module may be incorporated into the phone case/protector button. The haptic module includes a sensor 1020 positioned underneath the conductive region 1010, a PCB 1040 which may be positioned on a substrate, and a haptic device 1050 for providing haptic feedback to the user upon actuation of the phone case/protector button 1010. Haptic feedback may be useful for capacitive buttons that also have a click actuation function. In some actuator buttons, there are different “click” levels such as half-click or full-click. For example, in iPhone 16s, a half-click and hold of the phone actuator button would allow users to enter the camera setting menu or the zoom function. Thus, for instance, when the phone case/protector button 1010 is pressed down to a certain predetermined position, the signal is sensed by the sensor 1020 which is then processed by the PCB 1040 and transmitted to the haptic device 1050 to give a haptic feedback to the user. By incorporating a haptic module in the button, the user can “feel” the difference between a half-click and full-click when depressing the phone case/protector button.

Alternatively, some phone cases/protectors are provided with a cut-out portion that enables the use to make direct contact with the underlying capacitive actuator button. In order to protect the capacitive actuator button, the phone case/protector may include a moveable flap 1110 that covers the actuator button when not in use but may be easily pushed aside for direct contact of a user's finger or stylus with the phone actuator button. This embodiment is depicted in FIG. 15.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints.

1. A mobile device protector comprising:
an edge wall portion including at least one region covering a mobile device capacitive actuator button on a mobile device, wherein the mobile device capacitive actuator button is adjacent to the at least one region;
the at least one region being an at least partially electrically conductive region with a conductivity sufficient to transmit a change in capacitance due to a user's digit or stylus approaching the mobile device capacitive actuator button on the mobile device for actuating the mobile device capacitive actuator button as a result of a change in capacitance.

2. The mobile device protector of claim 1, wherein the at least one region includes a mobile device protector button.

3. The mobile device protector of claim 2, wherein the mobile device protector button includes at least one electrically conducting region and at least one electrically non-conducting region.

4. The mobile device protector of claim 3, wherein the at least one electrically conducting region comprises a conductive polymer.

5. The mobile device protector of claim 4, wherein the conductive polymer is in the form of conductive particle, wire, or rod.

6. The mobile device protector of claim 5, wherein the conductive particle, wire, or rod is embedded in a polymer matrix.

7. The mobile device protector of claim 5, wherein the conductive particle, wire, or rod at least partially includes carbon, graphite, carbon nanotubes, graphene, silver, copper, aluminum, nickel, conductive ceramics, or mixtures thereof.

8. The mobile device protector of claim 6, wherein the polymer matrix includes an elastomer, a thermoplastic resin, a thermoset resin, or mixtures thereof.

9. The mobile device protector of claim 6, wherein the polymer matrix includes an elastomer selected from one or more of silicone, polyurethane, thermoplastic polyurethane, thermoplastic elastomers, or acrylonitrile butadiene styrene (ABS).

10. The mobile device protector of claim 6, wherein the polymer matrix includes a thermoplastic resin or a thermoset resin selected from polyethylene, polyethylene terephthalate, polytetrafluoroethylene, polystyrene, polycarbonate, polybutylene, polyvinyl chloride, polyester, polyimide, polyamide, or polypropylene.

11. The mobile device protector of claim 2, wherein the mobile device protector button includes vertical or horizontal layers of conducting and nonconducting regions.

12. The mobile device protector of claim 2, wherein the mobile device protector button includes apertures or voids therewithin.

13. The mobile device protector of claim 2, wherein the mobile device protector button is positioned to be at least partially physically separated from the mobile device capacitive actuator button by an air gap before actuation.

14. The mobile device protector of claim 13, wherein upon actuation of the mobile device protector button, the mobile device protector button is configured to displace the air gap and press against the mobile device capacitive actuator button on the mobile device.

15. The mobile device protector of claim 2, wherein the mobile device protector button includes embedded sliding element and the mobile device protector button is positioned within a groove of the mobile device protector.

16. The mobile device protector of claim 15, wherein the embedded sliding element is in the form of a conductive rod, conductive spheres or conductive bead.

17. The mobile device protector of claim 2, wherein the mobile device protector button includes a protective layer positioned between the mobile device protector button and the mobile device capacitive actuator button.

18. The mobile device protector of claim 2, wherein the mobile device protector button further comprises a haptic feedback module.

19. The mobile device protector of claim 2, further comprising a back panel, wherein the edge wall portion at least partially extending from the back panel.

20. The mobile device protector of claim 16, further comprising a second edge wall portion at least partially extending from the back panel.
